(19) United States
(12) Patent Application Publication
(10) Pub. No.: US 2007/0036901 A1
(43) Pub. Date: Feb. 15, 2007

(54) Process for the manufacturing of a decorative surface elements with a surface structure

(75) Inventor: Ake Sjoberg, Lund (SE)

Correspondence Address: STEVENS DAVIS MILLER & MOSHER, LLP, 1615 L STREET, NW, SUITE 850, WASHINGTON, DC, 20036, US

(73) Assignee: Pergo (EUROPE) AB, Trelleborg (SE)

(21) Appl. No.: 10/580,255

(22) PCT Filed: Nov. 24, 2004
(86) PCT No.: PCT/SE04/01724

§ 371 Date: Jun. 7, 2006

(30) Foreign Application Priority Data
Nov. 25, 2003 (SE) 0303147-3

(51) Int. Cl. B05D 1/36; B05D 7/00

(52) U.S. Cl. 427/402

(57) ABSTRACT

A process for the manufacturing of a decorative surface element with surface structure, which element comprises a core material, a decorative surface layer and a protective upper wear layer. At least one of said decorative surface layer and said wear layer comprises a thermosetting resin. The process comprises the steps of providing the upper surface of the core material with a surface structure, applying the decorative surface layer on top of the surface structured core, applying the protective wear layer on the decorative surface layer and pressing the core material, decorative layer and wear layer under increased pressure and temperature in a laminate press so that resin cures and the different layers are bonded to one another.

### BACKGROUND OF THE INVENTION

1. Field of the Invention

The present invention relates to a process for the manufacture of decorative surface elements with a surface structure.

2. Description of Related Art

Products coated with simulated versions of materials such as wood and marble are frequent today. They are foremost used where a less expensive material is desired, but also where resistance towards abrasion, indentation and different chemicals and moisture is required. As an example of such products floors, floor beadings, table tops, work tops and wall panels can be mentioned.

As an example of an existing product can be mentioned the thermosetting laminate which mostly consists of a base with a decor sheet placed closest to the surface. The decor sheet can be provided with a desired decor or pattern. It is also common to arrange a wear layer on top of the decor sheet in order to protect it from wear. The decorative surface is most often provided with a surface structure during the lamination in order to increase the decorative effect. This is achieved by utilising a press belt, a press foil or a press plate, provided with structured surface, which is pressed towards the surface during the lamination procedure.

### SUMMARY OF THE INVENTION

According to the present invention it has been made possible to manufacture decorative surface elements where a different type of surface structure is achieved.

The process can be used when manufacturing surface elements like floor boards, wall panels and ceiling panels. Accordingly, the invention relates to a process for the manufacturing of a decorative surface element. The element comprises a core material, a decorative surface layer and a protective upper wear layer. At least one of said decorative surface layer and said wear layer comprises a thermosetting resin. The invention is characterised in that the process comprises the steps;
a) The upper surface of the core material is provided with a surface structure.
b) The decorative surface layer is then applied on top of the surface structured core.
c) The protective wear layer is then applied on the decorative surface layer.
d) The core material, the decorative layer and the wear layer is then pressed under increased pressure and temperature in a laminate press so that resin cures and the different layers are bonded to one another.

According to an alternative embodiment of the invention; a) the upper surface of the core material is provided with a surface structure. b) The decorative surface layer is then applied on top of the surface structured core. This surface layer may be an opaque or translucent lacquer, a printing ink or a decorated sheet. The lacquer may be applied by means of roller coating, curtain coating, transfer coating, air brushing, brushing or combinations thereof. The lacquer may be applied in several layers where at least one layer partially covers the surface in order to achieve a decorative pattern. The different lacquers then differs in colour. The application of the decorative pattern may be a guided operation where for example an air brush is guided by a computer aided robot. The printing ink may be applied by means of ink jet printing, screen printing, transfer printing or a combination thereof. c) The protective wear layer is then applied on the decorative surface layer. This wear layer may be a UV curing, electron beam curing, heat curing or multiple component lacquer, or resin. The lacquer or resin may be applied by means of roller coating, curtain coating, transfer coating, air brushing, brushing or combinations thereof. The lacquer or resin may be applied in several layers and may also contain fibre for reinforcement and/or hard particles for abrasion resistance. The fibre may be for example cellulose fibre while the particles may be of aluminum oxide, silicon oxide or silicon carbide which particles have an average particle size in the range 1 μm-150 μm. d) The lacquer and or resin is then cured and the different layers are bonded to one another.

According to one embodiment of the invention the surface structure of the core material is achieved by milling a desired surface into the upper surface of the core material.

According to another embodiment of the invention the surface structure of the core material is achieved by pressing a structured press plate or press roller on top of the upper surface of the core material.

According to yet another embodiment of the invention the surface structure of the core material is achieved by rolling the core material between at least one surface structured calendar roller and a counter-stay roller.

According to yet another embodiment of the invention the surface structure of the core material is achieved by partially wetting the upper surface of the core material with a solvent.

According to yet another embodiment of the invention the surface structure of the core is achieved by wetting the upper surface of the core material with a solvent whereupon a structured press plate or roller is pressed onto said upper surface.

The decorative surface layer suitably comprises a cellulose sheet impregnated with an amino resin. The amino resin is suitably selected from the group consisting of melamine formaldehyde resin, urea formaldehyde resin and mixtures thereof.

The wear layer suitably also comprises a cellulose sheet impregnated with an amino resin selected from the group consisting of melamine formaldehyde resin, urea formaldehyde resin and mixtures thereof. It is of course possible to use more than one such cellulose sheets in the wear layer for increased wear resistance.

The wear layer may further comprise hard particles selected from the group consisting of aluminium oxide, silicon oxide and silicon carbide having an average particle size in the range 50 nm-150 μm in order to further increase the wear resistance. The scratch resistance may be increased by providing the uppermost surface of the wear layer is provided with hard particles selected from the group consisting of aluminium oxide, silicon oxide and silicon carbide having an average particle size in the range 50 nm-30 μm.

It is advantageous to utilise a press cushion arranged on top of the wear layer during the pressing.

It is alternatively possible to use a press plate having a surface structure matching the surface structure of the core material is arranged on top of the wear layer during the pressing. This does however require that the structure on the surface of the base material is accurately machined to match the structure of the press plate.

The surface structure will of course comprise different features and can be described as macro structure and micro structure. The macro structure is in the present invention comprised of the structure arranged on the core material. It will here be possible to simulate for example the recessed grout line between ceramic tiles as well as the rough irregular surface of the ceramic tile itself. It is also possible to simulate worn wood like when the softer parts of the wood becomes recessed while the resin rich parts of the wood withstand wear and therefore protrudes. The micro structure is used for simulating pores in wood, granular structure, sanding mark structure, milling mark structure, micro cracks and flat to gloss surfaces. It is accordingly suitable to utilise a press foil provided with a micro structure which is arranged on top of the wear layer during the pressing. A press cushion is suitably arranged between the press foil and the press during the pressing.

The base layer suitably consists of a particle board or a fibre board.

1. A process for the manufacturing of a decorative surface element with surface structure, which element comprises a core material, a decorative surface layer and a protective upper wear layer, where at least one of said decorative surface layer and said wear layer comprises a thermosetting resin, wherein the process comprises the steps:
a) providing the upper surface of the core material with a surface structure,
b) applying the decorative surface layer on top of the surface structure core,
c) applying the protective wear layer on the decorative surface layer, and
d) pressing the core material, decorative layer and wear layer under increased pressure and temperature in a laminate press so that resin sures and the different layers are bonded to one another.

2. A process according to claim 1 wherein the surface structure of the core material is achieved by machining a desired surface into the upper surface of the core material.

3. A process according to claim 1 wherein the surface structure of the core material is achieved by pressing a structured press plate or press roller on top of the upper surface of the core material.

4. A process according to claim 1 wherein the surface structure of the core material is achieved by partially wetting the upper surface of the core material with a solvent.

5. A process according to clam 1 wherein the surface structure of the core is achieved by wetting the upper surface of the core material with a solvent whereupon a structured press plate or roller is pressed onto said upper surface.

6. A process according to claim 1 wherein the surface structure of the core material is achieved by rolling the core material between at least one surface structured calendar roller and a counter-stay roller.

7. A process according to claim 1 wherein the decorative surface layer comprises a cellulose sheet impregnated with an amino resin selected from the group consisting of melamine formaldehyde resin, urea formaldehyde resin and mixtures thereof.

8. A process according to claim 1 wherein the wear layer comprises a cellulose sheet impregnated with an amino resin selected from the group consisting of melamine formaldehyde resin, urea formaldehyde resin and mixtures thereof.

9. A process according to claim 8 wherein the wear layer further comprises hard particles selected from the group consisting of aluminium oxide, silicon oxide and silicon carbide having an average particle size in the range 50 nm-150 μm.

10. A process according to claim 8 wherein the uppermost surface of the wear layer is provided with hard particles selected from the group consisting of aluminium oxide, silicon oxide and silicon carbide having an average particle size in the range 50 nm-30 μm.

11. A process according to claim 1 wherein a press cushion is arranged on top of the wear layer during the pressing.

12. A process according to claim 1 wherein a press plate having a surface structure matching the surface structure of the core material is arranged on top of the wear layer during the pressing.

13. A process according to claim 1 wherein a press foil provided with a micro structure is arranged on top of the wear layer during the pressing.

14. A process according to claim 1 wherein a press cushion is arranged between the press foil and the press during the pressing.

15. A process according to claim 1 wherein the base layer consists of a particle board.

16. A process according to claim 1 wherein the main part of the base layer comprises fibre board.
